(19) United States
(12) Patent Application Publication
(10) Pub. No.: US 2012/0183722 A1
(43) Pub. Date: Jul. 19, 2012

(54) GREEN SHEET AND MANUFACTURING METHOD THEREOF

(75) Inventors: Wonseop CHOI, Gyeonggi-do (KR); Jaehun Choe, Gyeonggi-do (KR); Junghwan Kim, Gyeonggi-do (KR); Daebok O, Seoul (KR); Jaesung Park, Gyeonggi-do (KR)

(73) Assignee: SAMSUNG ELECTRO-MECHANICS CO., LTD.

(21) Appl. No.: 13/165,491

(22) Filed: Jun. 21, 2011

(30) Foreign Application Priority Data
Jan. 13, 2011 (KR) 10-2011-0003515

(51) Int. Cl. B32B 7/06; B05D 5/12; H05H 1/00; B32B 18/00

(52) U.S. Cl. 428/78; 428/446; 428/202; 427/79; 427/535

(57) ABSTRACT

The present invention provides a green sheet, for use in a multilayered ceramic capacitor having a super-micro high-capacity, without a wave defects at lateral sides of a green sheet, and a manufacturing method thereof. The method includes forming a release layer on a substrate film; modifying the surface of the release layer to obtain different surface energy levels at the center and both ends of the release layer; and forming a green sheet layer on the release layer.

### CROSS-REFERENCE TO RELATED APPLICATIONS

Claim and incorporate by reference domestic priority application and foreign priority application as follows:

This application claims the benefit under 35 U.S.C. Section 119 of Korean Patent Application Serial No. 10-2011-0003515, entitled filed Jan. 13, 2011, which is hereby incorporated by reference in its entirety into this application.

### BACKGROUND OF THE INVENTION

1. Field of the Invention

The present invention relates to a green sheet for use in a multilayered ceramic capacitor and a manufacturing method thereof.

2. Description of the Related Art

Incorporating a high-capacity electronic device in a compact equipment such as a Smart Phone, requires a mass of chips per unit volume. With such a requirement, a number of studies are under way on a super-micro high-capacity multilayered ceramic capacitor.

Producing a multilayered ceramic capacitor having a small size and a high-capacity, requires an increase in a capacity per unit volume. To do this, various methods such as increasing a dielectric constant of a dielectric power, decreasing the thickness of the dielectric substance, increasing coverage of an internal electrode or the like, are provided.

Reduction of the thickness of a green sheet gives a decrease in thickness of the dielectric substance. The green sheet is formed by drying slurry to be used in manufacturing the multilayered ceramic capacitor which is coated on a substrate with silicon formed thereon. A low degree of viscosity or a low surface energy of silicon-coated substrate is needed to obtain a super-thin film green sheet. Unfortunately, under such a condition, the drying causes a mass of wave defects which is generated at both sides of the green sheet. The wave defects cause a floating or an edge peeling, which are generated at both sides of the green sheet.

The slurry, which is used in manufacturing the multilayered ceramic capacitor, is made by maxing and dispersing a dielectric power, a solvent, a dispersant and a binder. The green sheet is made by coating the as-dispersed slurry on a silicon-based release layer formed on the substrate and followed by drying.

The production of slurry having a thickness of e.g., 2 or lower, requires conditions that the slurry has a high dispersibility, a proper drying rate, and a low solid content corresponding to a degree of processing of die head. As such, the slurry has a low level of viscosity. Drying shrinkage of the slurry increases as the solid content and the viscosity of the slurry decreases. In addition, surface energy of the silicon-based release layer formed on the substrate is lower than that of the slurry, which manifests a mass of wave defects at both sides of the green sheet while coating and drying the slurry.

FIG. 1 is a top view (including a sectional view) showing a green sheet, a silicon-based release layer and a substrate film (PET film), as viewed from the top side thereof. A silicon-based release layer 20 is coated over the entire surface of a PET film 10. In this arrangement, a green sheet layer 30 is formed only on the silicon-based release layer 20. As a result, a contact angle at both sides of the green sheet layer 30 is higher than 90 degree, which causes wave defects 50. The wave defects 50 cause an edge peeling, a floating, or the like during a sequence of subsequent printing and laminating processes.

### SUMMARY OF THE INVENTION

The present invention has been invented in order to overcome the above-described problems and it is, therefore, an object of the present invention to provide a green sheet, for use in a multilayered ceramic capacitor having a super-micro high-capacity, without causing wave defects at lateral sides of a green sheet.

The present invention has been invented in order to overcome the above-described problems and it is, therefore, another object of the present invention to provide a method of manufacturing a green sheet without causing wave defects at lateral sides of a green sheet.

In accordance with one aspect of the present invention to achieve the object, there is provided a green sheet, which comprises a substrate film, a release layer formed on the substrate film, and a green sheet layer formed on the release layer. Wherein, the substrate film, the release layer and the green sheet layer are sequentially laminated. The release layer has different surface energy levels at the center and both ends thereof.

The surface energy of the release layer may be set to be low at the center of the release layer and is set to be high at the both ends thereof.

Surface-processed layers may be formed on the both ends of the release layer.

The surface-processed layers formed on the both ends of the release layer may be formed from a cut portion of the green sheet layer to an end portion of the substrate film.

The surface process performed on the release layer may include at least one of a plasma process, an insertion process of extraneous substance to the release layer, and an organic solvent process.

A contact angle between the surface-processed layers formed on the green sheet layer and the release layer may be set to be less than 90 degree.

Further, in accordance with another aspect of the present invention to achieve the object, there is provided a method of manufacturing a green sheet, which comprises forming a release layer on a substrate film, modifying the surface of the release layer to obtain different surface energy levels at the center and both ends of the release layer, and forming a green sheet layer on the release layer.

The modifying may be performed by forming surface-processed layers on the both ends of the release layer.

The surface process performed on the release layer may include at least one of a plasma process, an insertion process of extraneous substance to the release layer, and an organic solvent process.

The plasma process may be selectively performed at the both ends of the release layer.

The insertion process of extraneous substance to the release layer may be performed by applying a physical means on the both ends of the release layer.

The organic solvent process may be performed by using at least one solvent selected from the group consisting of toluene, ethyl alcohol, n-Butanol, and Acetone.

The surface energy of the release layer may be set to be low at the center of the release layer, and is set to be high at the both ends thereof.

In the green sheet layer, a portion having a low surface energy may be coated wholly, and a portion having a high surface energy may be coated partially or wholly.

The width of a cut portion of the green sheet layer may be equal to or smaller than the width of the portion having the low surface energy.

According to the present invention, the level of surface energy at both ends of a release layer are set be higher than that of the center thereof, which prevents wave defects from being generated at a green sheet. Further, reducing the thickness of the green sheet allows a solid content and a viscosity to be adjusted to a predetermined level, which reduces the thickness of a dielectric substance. Through the use of the dielectric substance, it is possible to increase a capacity per unit volume to thereby apply the green sheet in various multilayered ceramic capacitors.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a top view (including a sectional view) showing a green sheet, a silicon-based release layer and a substrate film (PET film), as viewed from the top side thereof;

FIGS. 2A and 2B are a sectional view showing a process of modifying the surface of the release layer by using the plasma process, respectively;

FIG. 3 is a top view (including a sectional view) showing a structure of a green sheet film on which surface-processed layers are formed after a surface process;

FIG. 4 is a graph showing experimental results of a contact angle from a comparative example and embodiments;

FIG. 5 is a graph showing experimental results representative of a variation in structure of a silicon-based release layer in a comparative example and embodiments, where FT-IR measurement is employed; and

FIG. 6 is a photograph of wave defects which is manifested on a green sheet film in a comparative example and embodiments.

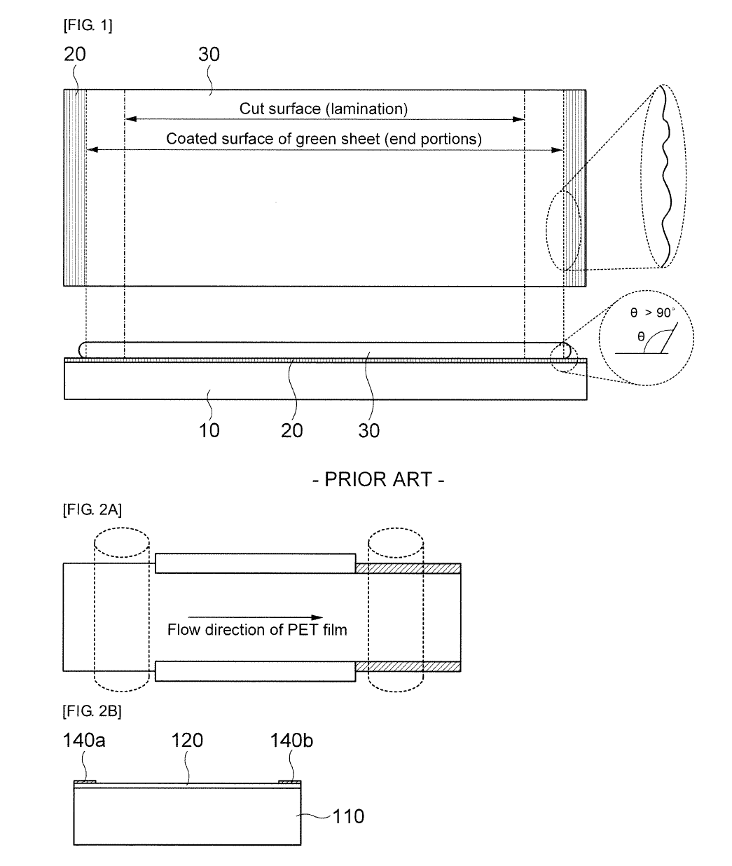

### DETAILED DESCRIPTION OF THE PREFERABLE EMBODIMENTS

Hereinafter, specific embodiments of the present invention will be described with reference to the accompanying drawings. However, the following embodiments are provided as examples but are not intended to limit the present invention thereto.

Descriptions of well-known components and processing techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

The technical spirit of the present invention should be defined by the appended claims, and the following embodiments are merely examples for efficiently describing the technical spirit of the present invention to those skilled in the art.

The present invention relates to a method for increasing a capacity per unit volume which is required for an MLCC (multilayered ceramic capacitor) having a super-micro high capacity, more particularly, a method which reduces the thickness of a green sheet to decrease the thickness of a dielectric substance.

To do this, the green sheet according to the present invention is formed in a structure in which a substrate film, a release layer and a green sheet layer are sequentially laminated. The release layer has different surface energy levels at the center and both ends thereof. Specifically, in the release layer, the surface energy at the center is low and that at both ends is high.

The reason for this is that the surface energy of the release layer formed on the substrate film is lower than that of slurry which is used in forming the green sheet layer, which manifests a mass of wave defects at both sides of the green sheet while coating and drying the slurry.

In the present invention, by surface-modifying the both ends of the release layer, surface-processed layers are obtained to generate a difference between the surface energy levels at the center and the both ends of the release layer. That is to say, the surface modification activates the release layer to increase the surface energy of the release layer.

The surface process to be performed on the release layer may include at least one of a plasma process, an insertion process of extraneous substance to the release layer, and an organic solvent process, but not limited thereto. For example, various processes may be employed as long as it can increase the surface energy at both ends of the release layer.

The surface-processed layers formed on the both ends of the release layer may be formed from a cut portion of the green sheet layer to an end portion of the substrate film. The release layer is formed on the substrate film and then the green sheet layer is formed on the release layer. In this case, the green sheet layer is formed with being spaced at a certain distance from the both ends of the release layer, without being formed over the entire surface of the release layer. Further, the green sheet is cut and laminated with being spaced at a certain distance from a coated surface of the green sheet layer.

Therefore, in the present invention, the surface-processed layers formed on the both ends of the release layer are formed from the cut portion of the green sheet layer to the end portion of the substrate film. In this case, a contact angle between the surface-processed layers formed on the green sheet layer and the release layer may be kept to less than 90 degree. Specifically, if the surface energy of the release layer is high at both sides of the substrate film, the contact angle between both sides of the green sheet is set to be lower than 90 degree. Thus, the high surface energy at the both sides of the substrate film allows the green sheet to be strongly attached on the substrate film, which results in a high adhesive force.

It is should be noted that the surface energy at a surface (i.e., the center of the release layer) on where the green sheet is printed is kept at a low level. In a laminating process, since the surface on which the green sheet is printed is laminated after abrasion, there is needed to keep a surface energy of an underlying release layer at a low level. In addition, it is should be noted that the both sides of the green sheet is strongly attached to the release layer, to thereby prevent the both sides of the green sheet from being previously striped away from the release layer.

In the following, a detailed description will be made as to a method of manufacturing a green sheet with reference to drawings. The method may include preparing a substrate film to form a release layer on the substrate film, changing a surface energy of the release layer, and forming a green sheet layer on the release layer.

The substrate film may be preferably formed of polyethylene terephthalate, but not limited thereto. The thickness of the substrate film may be set to the order of that of a green sheet which is generally used, but not limited thereto.

Further, the release layer formed on the substrate film may be preferably made of silicon, but not limited thereto.

The surface process by which the surface-processed layer is formed on the both ends of the release layer, may include at least one of a plasma process, an insertion process of extraneous substance to the release layer, and an organic solvent process, but not limited thereto. For example, other processes which modify the surface of the release layer to increase the surface energy thereof may be employed.

In the surface process as described above, the plasma process is properly adjusted to selectively perform the surface-modification only at both ends of the release layer. In a roll-to-roll-based coating process, a high-speed coating fails to process only the both ends of the release layer in a plasma state. Accordingly, an adjustment is required to form the surface-processed layers only on a selectively-defined region at the both ends of the release layer. The plasma process generates plasma radicals to increase a coupling energy at the both ends of the release layer. In this arrangement, the higher surface energy reduces wave defects such as a floating, which is generated when the both ends of the release layer passes through a roll during printing and laminating.

Since a condition of the plasma process may be varied according to the type of a plasma equipment to be used, the presence or absence of the wave defects is not be determined based on the condition. Various plasma conditions and equipments may be employed as long as it is allowable to perform the plasma process only on the selectively defined region at the both ends of the release layer.

In the organic solvent process, at least one solvent selected from the group consisting of toluene, ethyl alcohol, n-butanol, and acetone are coated on the release layer. Subsequently, a dry process is performed on the solvent formed on the release layer. Thus, the surface of the release layer is modified.

And, the insertion process of extraneous substance to the release layer applies a physical means on the both ends of the release layer to thereby modify the surface of the release layer. The physical means may include various extraneous substances other than the organic solvent as long as it can apply a physical pressure.

FIGS. 2A and 2B are a sectional view showing a process of modifying the surface of the release layer by using the plasma process, respectively. A silicon-based release layer 120 is formed on a PET film 110 as the substrate film with the same size as the width of the substrate film. Subsequently, surface-processed layers 140a, 140b are formed on the both ends of the release layer 120 by the plasma process.

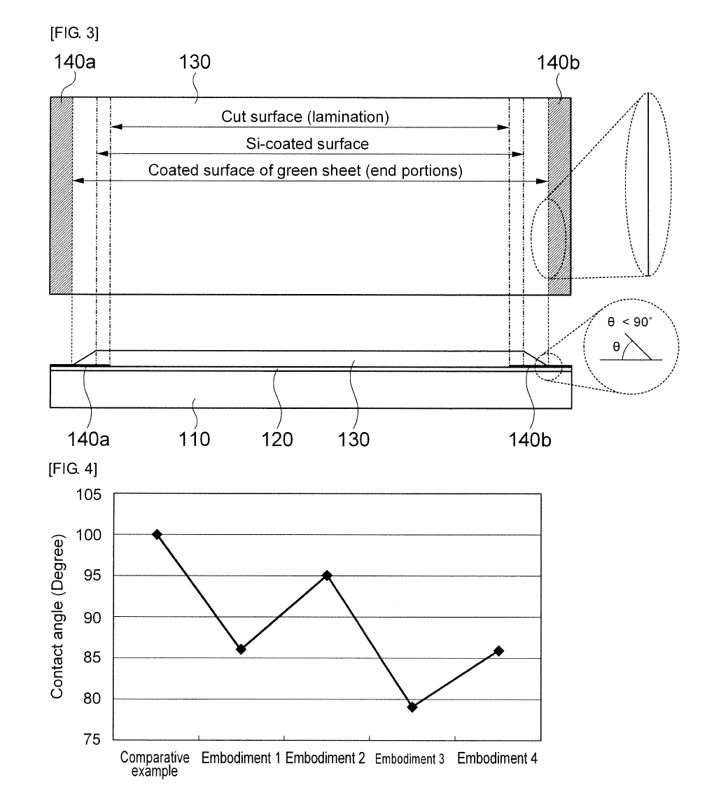

As described above, the both ends of the release layer are surface-modified so that the surface energy of the silicon-based release layer 120 according to the present invention is adjusted to be low at the center thereof and to be high at the both ends thereof, as shown in FIG. 3. This adjustment allows a surface having different surface energy levels to be positioned at one side, and controls a level of surface energy at the both ends of the release layer, which avoids the occurrence of wave defects.

As stated above, the green sheet layer 130 is coated on the silicon-based release layer 120 in which one side have different surface energy levels. Composition of the slurry making up the green sheet layer 130 is obtained by maxing and dispersing a dielectric power, a solvent, a dispersant and a binder, but not limited thereto.

Further, as mentioned above, the surface-processed layers 140a, 140b are formed on the both ends of the release layer 120 so that the contact angle between the surface-processed layers 140a, 140b formed on the green sheet layer 130 and the silicon-based release layer 120 is kept to be less than 90 degree.

In the green sheet layer 130, while the center of the silicon-based release layer 120 having a low surface energy is coated wholly, the both ends of the release layer 120 having a high surface energy is coated partially or wholly. The center of the silicon-based release layer 120 is stripped away during the laminating process. As such, the surface energy at the center of the silicon-based release layer 120 should be set to be low.

Preferably, the width of a cut surface of the green sheet layer 130 may be equal to or smaller than the width of the center of the silicon-based release layer 120. Specifically, the cut surface of the green sheet layer 130 may be preferably formed inside the silicon-based release layer 120.

In the following, the present invention will now be described in detail with reference to embodiments, a comparative example and experimental examples.

### First to Fourth Embodiments

A silicon-based release layer is formed on a substrate film made of FET. Subsequently, a surface-processed layer is formed on both ends of the silicon-based release layer by a plasma process. A slurry composition is coated on the silicon-based release layer to thereby produce a green sheet layer.

In the first to fourth embodiments, the plasma process is performed different conditions, for example, 7 kV and 5 m/min, 7 kV and 10 m/min, 14 kV and 5 m/min, and 14 kV and 10 m/min.

### Comparative Example

A green sheet is manufactured based on the first embodiment as described above without using the plasma process which is performed on the both ends of the release layer.

### Experimental Example 1

### Variation in Contact Angle

In the silicon-based release layer which is formed by performing the plasma process on the green sheet manufactured based on the first to fourth embodiments and the comparative example as described above, the inventors made the examination of a variation in contact angle with distilled water. The experimental showed the results as shown in FIG. 4.

As shown in FIG. 4, while the comparative example without having to use the plasma process, has shown that a contact angle is 100 degree, the experimental example has shown that the green sheet, which is manufactured by performing the plasma process on the both ends of the release layer, has a contact angle of less than 90 degree, wherein the contact angle is defined between surface-processed layers formed on the green sheet layer and the both ends of the release layer. Further, the experimental example has shown that the contact angle decreases as a time period of plasma exposure and an amount of plasma power increase.

### Experimental Example 2

### FT-IR Measurement

The inventors made the examination of a variation in structure of the silicon-based release layer, which is formed by performing the plasma process on the green sheet manufactured based on the first to fourth embodiments and the comparative example as described above, by using FT-IR (Fourier Transformer-Infrared Spectroscopy). The experimental showed the results as shown in FIG. 5.

As shown in FIG. 5, the experimental example has shown that there is little difference in structure of the green sheet layer between the comparative example where the plasma process is yet not performed and the embodiments where the plasma process has been performed. Specifically, in the present invention, the experimental example has shown that, even if the both ends of the silicon-based release layer is surface-modified, the structure thereof is kept in situ.

### Experimental Example 3

### Determination for Wave Defects

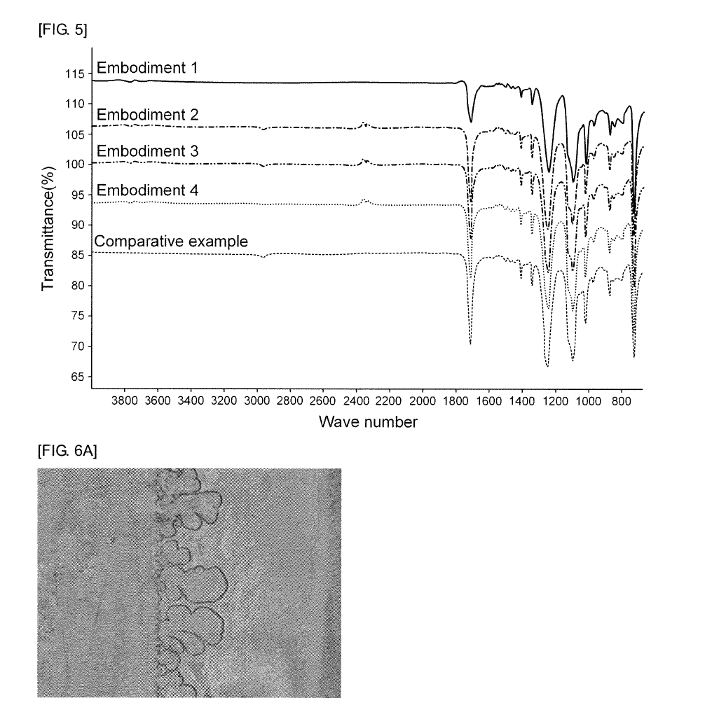

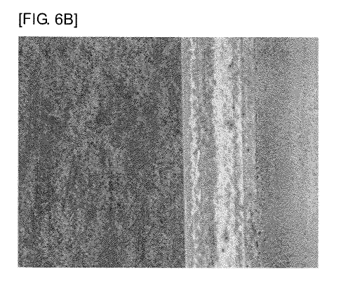

The inventors made the examination of wave defects before and after the silicon-based release layer, which is formed by performing the plasma process on the green sheet manufactured based on the first embodiments and the comparative example as described above, is surface-modified. The experimental showed the results as shown in FIGS. 6A and 6B.

As shown in FIG. 6A, the experimental example has shown that the comparative example shows an excessive wave defects on the green sheet layer.

Meanwhile, as shown in FIG. 6B, the embodiment where the green sheet layer is surface-modified has shown that the surface energy at the both ends of the release layer is high, thereby preventing the wave defects from being generated on the green sheet layer. Therefore, according to the present invention, the plasma process allows the surface energy at the both ends of the silicon-based release layer to be set at a high level. This prevents wave defects from being generated on the both ends of the thin-film green sheet, which reduces an edge peeling, a screen crack, or the like during printing and laminating processes.

While the invention has been described in detail with reference to preferred embodiments thereof, it will be appreciated by those skilled in the art that changes may be made in these embodiments without departing from the scope of the invention.

Thus, the scope of the invention should be determined by the appended claims and their equivalents, rather than by the described embodiments.

What is claimed is:

1. A green sheet, comprising:
a substrate film;
a release layer formed on the substrate film; and
a green sheet layer formed on the release layer,
wherein the substrate film, the release layer and the green sheet layer are sequentially laminated,
wherein the release layer has different surface energy levels at the center and both ends thereof.

2. The green sheet according to claim 1, wherein the surface energy of the release layer is set to be low at the center of the release layer and is set to be high at the both ends thereof.

3. The green sheet according to claim 1, wherein surface-processed layers are formed on the both ends of the release layer.

4. The green sheet according to claim 3, wherein the surface-processed layers formed on the both ends of the release layer is formed from a cut portion of the green sheet layer to an end portion of the substrate film.

5. The green sheet according to claim 3, wherein the surface process performed on the release layer includes at least one of a plasma process, an insertion process of extraneous substance to the release layer, and an organic solvent process.

6. The green sheet according to claim 1, wherein a contact angle between the surface-processed layers formed on the green sheet layer and the release layer is set to be less than 90 degree.

7. A method of manufacturing a green sheet, comprising:
forming a release layer on a substrate film;
modifying the surface of the release layer to obtain different surface energy levels at the center and both ends of the release layer; and
forming a green sheet layer on the release layer.

8. The method according to claim 7, wherein the modifying is performed by forming surface-processed layers on the both ends of the release layer.

9. The method according to claim 8, wherein the surface process performed on the release layer includes at least one of a plasma process, an insertion process of extraneous substance to the release layer, and an organic solvent process.

10. The method according to claim 9, wherein the plasma process is selectively performed at the both ends of the release layer.

11. The method according to claim 9, wherein the insertion process of extraneous substance to the release layer is performed by applying a physical means on the both ends of the release layer.

12. The method according to claim 9, wherein the organic solvent process is performed by using at least one solvent selected from the group consisting of toluene, ethyl alcohol, n-butanol, and acetone.

13. The method according to claim 7, wherein the surface energy of the release layer is set to be low at the center of the release layer and is set to be high at the both ends thereof.

14. The method according to claim 7, wherein in the green sheet layer, a portion having a low surface energy is coated wholly, and a portion having a high surface energy is coated partially or wholly.

15. The method according to claim 7, wherein the width of a cut portion of the green sheet layer is equal to or smaller than the width of the portion having the low surface energy.
